(19) United States
(12) Patent Application Publication
(10) Pub. No.: US 2025/0083922 A1
(43) Pub. Date: Mar. 13, 2025

(54) MEDIUM STACKING DEVICE

(71) Applicant: SEIKO EPSON CORPORATION, Tokyo (JP)

(72) Inventors: Kodai KITANO, MATSUMOTO-SHI (JP); Shun ITO, MATSUMOTO-SHI (JP); Yosuke NAKANO, MATSUMOTO-SHI (JP); Atsuhiko TAKEUCHI, MATSUMOTO-SHI (JP)

(21) Appl. No.: 18/882,082

(22) Filed: Sep. 11, 2024

(30) Foreign Application Priority Data
Sep. 13, 2023 (JP) 2023-148525

(51) Int. Cl. B65H 31/26

(52) U.S. Cl. CPC B65H 31/26; B65H 2301/32

(57) ABSTRACT

A medium stacking device on which a medium discharged from a processing device is stacked includes a stacking unit on which a medium is stacked, the stacking unit extending in a first direction, wherein the stacking unit includes a supporting member configured to support a medium, and a first protruding member and a second protruding member each positioned on a respective side of the supporting member in a second direction different from the first direction, the supporting member includes a supporting surface that supports a medium, the first protruding member includes a first protruding surface that supports a medium, the second protruding member includes a second protruding surface that supports a medium, and the first protruding surface and the second protruding surface are positioned above the supporting surface.

The present application is based on, and claims priority from JP Application Serial Number 2023-148525, filed Sep. 13, 2023, the disclosure of which is hereby incorporated by reference herein in its entirety.

### BACKGROUND

### 1. Technical Field

The present disclosure relates to a medium stacking device.

### 2. Related Art

JP-A-2022-68623 describes a medium stacking device on which a medium discharged from a processing device is stacked. In the medium stacking device, a medium stacked on a stacking unit may curl due to the curling tendency of the medium being rolled. When the medium curls on the stacking unit, a medium to be discharged from the processing device may be jammed. Thus, the medium stacking device includes a regulating member that presses the medium from above. With this, the curling tendency of the medium on the stacking unit is corrected.

In such a medium stacking device, the curling tendency of the medium may not sufficiently be corrected by the regulating member.

### SUMMARY

In order to solve the above-mentioned problem, a medium stacking device is a medium stacking device on which a medium discharged from a processing device is stacked, the medium stacking device including a stacking unit on which a medium is stacked, the stacking unit extending in a first direction, wherein the stacking unit includes a supporting member configured to support a medium, and a first protruding member and a second protruding member each positioned on a respective side of the supporting member in a second direction different from the first direction, the supporting member includes a supporting surface configured to support a medium, the first protruding member includes a first protruding surface configured to support a medium, the second protruding member includes a second protruding surface configured to support a medium, and the first protruding surface and the second protruding surface are positioned above the supporting surface.

### BRIEF DESCRIPTION OF THE DRAWINGS

FIG. 1 is a side view illustrating one embodiment of a medium stacking device that receives a medium discharged from a processing device.

FIG. 2 is a perspective view of the medium stacking device.

FIG. 3 is a front view of a supporting member.

FIG. 4 is a perspective view of the supporting member.

FIG. 5 is a perspective view obtained by folding a second stacking member from the state illustrated in FIG. 2.

FIG. 6 is a top view of a stacking unit.

FIG. 7 is a side view of the medium stacking device.

FIG. 8 is a side view obtained by displacing a first regulating member from the state illustrated in FIG. 7.

### DESCRIPTION OF EMBODIMENTS

With reference to the drawings, description is made on one embodiment of a medium stacking device on which a medium discharged from a processing device is stacked.

### Processing Device

First, a processing device is described. The processing device is, for example, an ink jet-type printer configured to eject ink serving as one example of a liquid onto a medium such as a sheet or fabric to print an image such as a character and a photo. The processing device may be a device that executes processing other than printing for a medium.

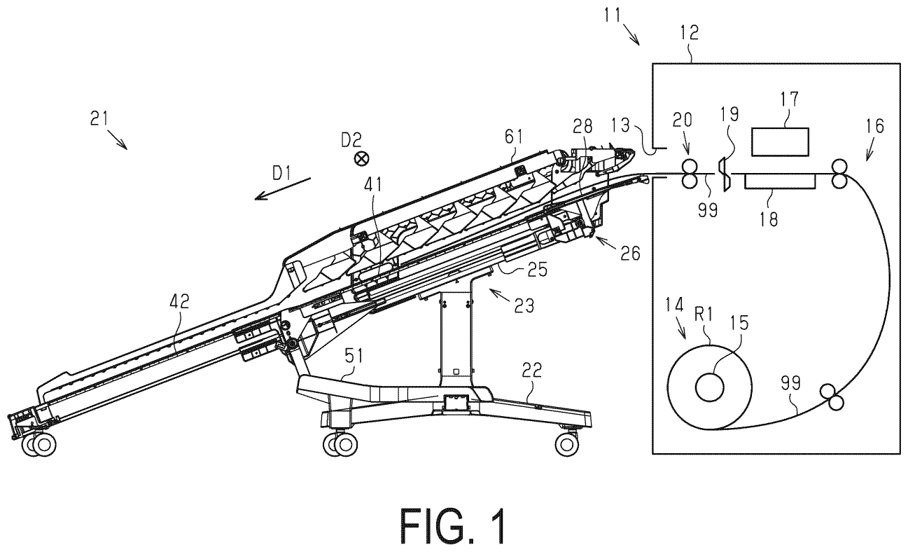

As illustrated in FIG. 1, a processing device 11 includes a housing 12. In the housing 12, a discharge port 13 through which a medium 99 is discharged opens. In one example, the discharge port 13 opens in the front surface of the housing 12. The processing device 11 discharges the medium 99 to the outside of the housing 12 through the discharge port 13. The processing device 11 discharges the medium 99 to the front. The processing device 11 discharges the medium 99 in a first direction D1. The processing device 11 discharges the medium 99 to a medium stacking device 21, which is described later.

The processing device 11 includes a feeding unit 14. The feeding unit 14 is configured to feed out the medium 99 from a roll body R1. The roll body R1 is formed by winding the medium 99 having an elongated shape. The feeding unit 14 unwind the medium 99 from the roll body R1 by rotating the roll body R1. The feeding unit 14 feeds out the medium 99 unwound from the roll body R1.

The feeding unit 14 includes a feeding-out shaft 15. The feeding-out shaft 15 is a shaft that supports the roll body R1. The feeding-out shaft 15 rotatably support the roll body R1. The feeding-out shaft 15 may support the roll body R1 by coming into contact with the inner circumference of the roll body R1, or may support the roll body R1 by coming into contact with the outer circumference of the roll body R1. The feeding-out shaft 15 is attached to the housing 12. The feeding-out shaft 15 may rotate with the roll body R1. The feeding unit 14 may rotate the roll body R1 by rotating the feeding-out shaft 15. The feeding-out shaft 15 may rotate with the roll body R1 while a transport unit 16, which is described later, pulls the medium 99.

The processing device 11 includes the transport unit 16. The transport unit 16 is configured to transport the medium 99. For example, the transport unit 16 includes one or more rollers. The transport unit 16 transport the medium 99 fed out by the feeding unit 14.

The processing device 11 includes a processing unit 17. The processing unit 17 is configured to execute processing for the medium 99. The processing unit 17 executes processing for the medium 99 transported by the transport unit 16. In one example, the processing unit 17 is configured to execute printing on the medium 99. For example, the processing unit 17 includes a head that ejects a liquid. The processing unit 17 prints an image on the medium 99 by ejecting the liquid onto the medium 99.

The processing device 11 includes a supporting unit 18. The supporting unit 18 supports the medium 99. The supporting unit 18 faces the processing unit 17. Specifically, the supporting unit 18 is positioned directly below the processing unit 17. The supporting unit 18 supports a part of the medium 99, which is subjected to processing by the processing unit 17. The supporting unit 18 supports the medium 99 transported by the transport unit 16.

The processing device 11 includes a cutting unit 19. The cutting unit 19 is configured to cut the medium 99. The cutting unit 19 cuts the medium 99 subjected to processing by the processing unit 17. For example, the cutting unit 19 includes a rotating blade. The cutting unit 19 generates the medium 99 having a strip shape by cutting the medium 99 having an elongated shape, which is fed out from the roll body R1.

The processing device 11 includes a discharge unit 20. The discharge unit 20 is configured to discharge the medium 99. For example, the discharge unit 20 includes one or more rollers. The discharge unit 20 discharges the medium 99 cut by the cutting unit 19, to the outside of the housing 12. The discharge unit 20 discharges the medium 99 to the medium stacking device 21 through the discharge port 13. The discharge unit 20 discharges the medium 99 in the first direction D1.

### Medium Stacking Device

Next, the medium stacking device 21 is described.

The medium stacking device 21 receives the medium 99 discharged from the processing device 11. On the medium stacking device 21, the medium 99 discharged from the processing device 11 is stacked. On the medium stacking device 21, the medium 99 unwound from the roll body R1 is stacked. The medium 99 has the curling tendency. Thus, the medium 99 easily curls on the medium stacking device 21. Specifically, the medium 99 easily curls in a form similar to that of being wound around the roll body R1. In one example, the medium 99 easily curls to protrude upward. In particular, the leading edge part and the trailing edge part of the medium 99 easily curl. When the medium 99 curls on the medium stacking device 21, there may be a risk that the medium 99 is jammed. Thus, the medium stacking device 21 is required to receive the medium 99 from the processing device 11 while suppressing curling of the medium 99. Further, the medium stacking device 21 is required to suppress curling of the medium 99 being stacked.

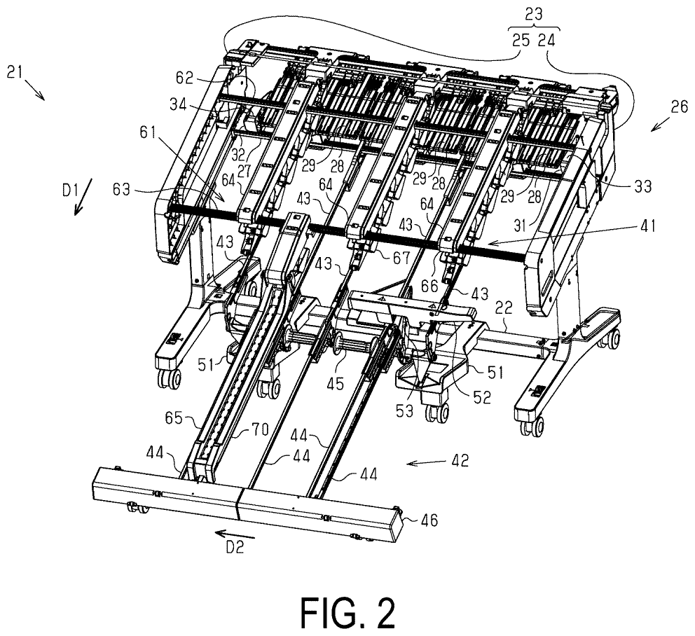

As illustrated in FIG. 2, the medium stacking device 21 includes a leg unit 22. The leg unit 22 comes into contact with a floor surface.

The medium stacking device 21 includes a main body unit 23. The main body unit 23 is attached to the leg unit 22. The main body unit 23 is supported on the leg unit 22. The main body unit 23 is positioned on the leg unit 22. The main body unit 23 is configured to support a stacking unit 26, which is described later.

The main body unit 23 includes two side frames. Specifically, the main body unit 23 includes a first side frame 24 and a second side frame 25. The first side frame 24 and the second side frame 25 extend in the first direction D1. The first direction D1 is a direction in which the stacking unit 26 extends. The first direction D1 is a direction serving as an indicator indicating a length from the trailing edge to the leading edge of the medium 99.

The first side frame 24 and the second side frame 25 are arrayed in a second direction D2. The second direction D2 is a direction different from the first direction D1. The second direction D2 is a direction intersecting with the first direction D1. The second direction D2 is a direction serving as an indicator indicating a width of the medium 99. The first side frame 24 and the second side frame 25 are arrayed in the second direction D2 in the stated order. The first side frame 24 and the second side frame 25 face each other in the second direction D2.

The first side frame 24 and the second side frame 25 may guide the side edges of the medium 99. In other words, the first side frame 24 and the second side frame 25 may guide the respective edges of the medium 99 in the second direction D2. In one example, the medium 99 may be discharged from the processing device 11 to the medium stacking device 21 so that the side edge of the medium 99 aligns with the first side frame 24. When the medium 99 having a small width is discharged along the first side frame 24 from the processing device 11, the first side frame 24 may guide the side edge of the medium 99, whereas the second side frame 25 may not guide the side edge of the medium 99. The medium 99 may be discharged from the processing device 11 to the medium stacking device 21 so that the center of the medium 99 matches with the intermediate position between the first side frame 24 and the second side frame 25.

The medium stacking device 21 includes the stacking unit 26. The stacking unit 26 is attached to the first side frame 24 and the second side frame 25. On the stacking unit 26, the medium 99 is stacked. The stacking unit 26 receives the medium 99 discharged from the processing device 11. The stacking unit 26 supports the medium 99 from below.

The stacking unit 26 extends in the first direction D1. Thus, the medium 99 is stacked on the stacking unit 26 while extending in the first direction D1. The medium 99 is stacked on the stacking unit 26 by advancing in the first direction D1 from the processing device 11. In one example, the first direction D1 is an obliquely downward direction. Thus, the medium 99 advances so as to slide on the stacking unit 26 due to the gravity. With this, the medium 99 is smoothly stacked on the stacking unit 26.

The stacking unit 26 includes a bridging member 27. The bridging member 27 extends in the second direction D2. The bridging member 27 is bridged between the first side frame 24 and the second side frame 25. With this, the rigidity of the main body unit 23 is improved.

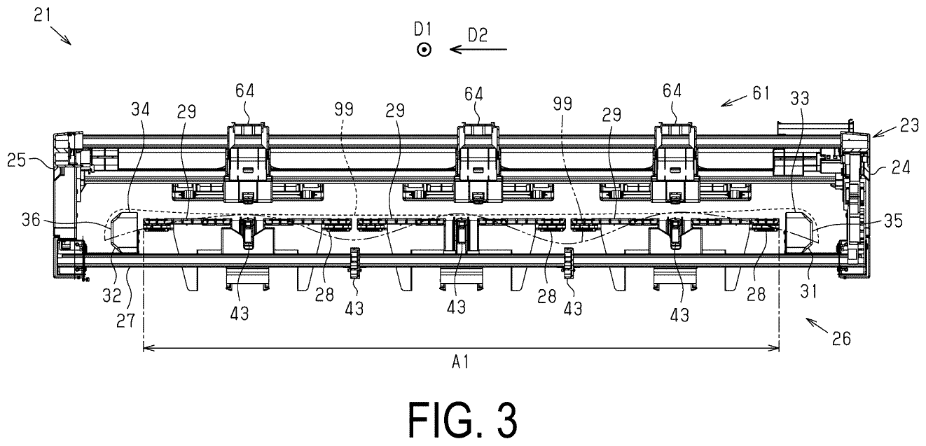

As illustrated in FIG. 2 and FIG. 3, the stacking unit 26 includes one or more supporting members 28. In one example, the stacking unit 26 includes three supporting members 28. The three supporting members 28 are arrayed in the second direction D2. The three supporting members 28 may be integrally configured. For example, the stacking unit 26 may include one supporting member 28 elongated in the second direction D2.

The supporting member 28 is attached to the bridging member 27. The supporting member 28 is supported on the bridging member 27. The supporting member 28 is positioned on the bridging member 27. For example, the supporting member 28 is a rectangular plate member.

The supporting member 28 supports the medium 99 discharged from the processing device 11. The supporting member 28 receives the leading edge of the medium 99 discharged through the discharge port 13. The supporting member 28 guides the leading edge of the medium 99 into the medium stacking device 21. The supporting member 28 supports the trailing edge of the medium 99 stacked on the stacking unit 26.

The supporting member 28 includes a supporting surface 29. The supporting surface 29 is a surface that supports the medium 99. The supporting surface 29 is a surface of the supporting member 28 that faces upward. The supporting member 28 receives the medium 99 by the supporting surface 29. The supporting member 28 receives the leading edge of the medium 99 by the supporting surface 29, and hence the posture of the medium 99 is easily stabilized. Thus, the supporting member 28 easily guides the medium 99 in the first direction D1. Even when the supporting member 28 receives the leading edge of the medium 99 by a small surface area, there may be a risk that the posture of the medium 99 is less likely to be stabilized and the leading edge of the medium 99 easily curls.

The supporting member 28 supports a part of the medium 99, which is positioned in a supporting region A1 in the second direction D2. The supporting region A1 is a region occupied by the supporting members 28 in the second direction D2. In other words, when the stacking unit 26 includes the one supporting member 28, the length of the supporting region A1 corresponds to the width of the supporting member 28. When the stacking unit 26 includes the plurality of supporting members 28, the length of the supporting region A1 corresponds to the width of the plurality of supporting members 28 as a whole. As the length of the supporting region A1 is larger, the supporting member 28 easily receives the leading edge of the medium 99 in a more stabilized manner.

The stacking unit 26 includes two protruding members. Specifically, the stacking unit 26 includes a first protruding member 31 and a second protruding member 32. The first protruding member 31 and the second protruding member 32 are attached to the bridging member 27. The first protruding member 31 and the second protruding member 32 are supported on the bridging member 27. The first protruding member 31 and the second protruding member 32 are positioned on the bridging member 27.

The first protruding member 31 and the second protruding member 32 are arrayed in the second direction D2 with the supporting member 28. The first protruding member 31 and the second protruding member 32 are each positioned on a respective side of the supporting member 28 in the second direction D2. Specifically, the first protruding member 31 is positioned between the first side frame 24 and the supporting member 28 in the second direction D2. The second protruding member 32 is positioned between the second side frame 25 and the supporting member 28 in the second direction D2. The first protruding member 31, the supporting member 28, and the second protruding member 32 are arrayed in the second direction D2 in the stated order. The first protruding member 31 and the second protruding member 32 are positioned outside of the supporting region A1 in the second direction D2.

The first protruding member 31 and the second protruding member 32 receives the medium 99. Specifically, the first protruding member 31 and the second protruding member 32 receive the leading edge of the medium 99 discharged from the processing device 11, in collaboration with the supporting member 28.

The first protruding member 31 and the second protruding member 32 support the medium 99. For example, the first protruding member 31 and the second protruding member 32 support the trailing edge of the medium 99 stacked on the stacking unit 26, in collaboration with the supporting member 28.

The first protruding member 31 and the second protruding member 32 are configured to protrude upward with respect to the supporting member 28. Thus, the first protruding member 31 and the second protruding member 32 support the medium 99 so as to lift up the medium 99 with respect to the supporting member 28. When the width of the medium 99 is small, the first protruding member 31 may support the medium 99, whereas the second protruding member 32 may not support the medium 99. An interval at which the first protruding member 31 and the second protruding member 32 are arranged is smaller than the maximum width of the medium 99 that can be stacked on the medium stacking device 21.

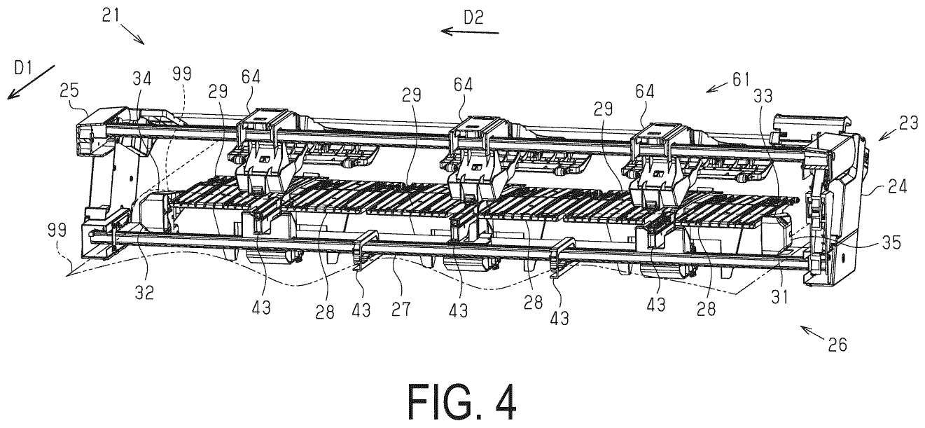

As illustrated in FIG. 3 and FIG. 4, the first protruding member 31 includes a first protruding surface 33. The first protruding surface 33 is a surface facing upward. The second protruding member 32 includes a second protruding surface 34. The second protruding surface 34 is a surface facing upward. The first protruding surface 33 and the second protruding surface 34 support the medium 99 discharged from the processing device 11, in collaboration with the supporting surface 29. The first protruding surface 33 and the second protruding surface 34 support the medium 99 stacked on the stacking unit 26, in collaboration with the supporting surface 29.

The first protruding surface 33 and the second protruding surface 34 are positioned above the supporting surface 29. The first protruding surface 33 and the second protruding surface 34 may be positioned at the same height. The part of the medium 99, which is supported on the first protruding member 31 and the second protruding member 32, is lifted up higher than the part thereof, which is supported on the supporting member 28. With this, a crease extending in the first direction D1 is formed on the medium 99 so as to intersect with the curling tendency. Due to this crease, the medium 99 is curved in the second direction D2. With this, the risk that the medium 99 curls due to the curling tendency is reduced. In particular, there is reduced a risk that the part of the medium 99 stacked on the stacking unit 26, which is supported on the first protruding member 31 or the second protruding member 32, curls due to the curling tendency.

The first protruding member 31 faces the first side frame 24. The first protruding member 31 includes a first facing surface 35. The first facing surface 35 is a surface facing the first side frame 24. In one example, the first facing surface 35 is oriented in a direction opposite to the second direction D2.

The first protruding member 31 is positioned away from the first side frame 24 at an interval in the second direction D2. Thus, depending on the flexibility of the medium 99, the side edge of the medium 99 may fall down between the first side frame 24 and the first protruding member 31. In other words, when the medium 99 is flexible, the medium 99 hangs down along the first facing surface 35. The medium 99 is curved downward along the first protruding member 31.

the second protruding member 32 faces the second side frame 25. The second protruding member 32 includes a second facing surface 36. The second facing surface 36 is a surface facing the second side frame 25. In one example, the second facing surface 36 is oriented in the second direction D2.

The second protruding member 32 is positioned away from the second side frame 25 at an interval in the second direction D2. Thus, when the medium 99 is supported on the second protruding member 32, the side edge of the medium 99 may fall down between the second side frame 25 and the second protruding member 32, depending on the flexibility of the medium 99. In other words, when the medium 99 is flexible, the medium 99 hangs down along the second facing surface 36. The medium 99 is curved downward along the second protruding member 32.

When the medium 99 has a large width, both the side edges of the medium 99 are curved along the first protruding member 31 and the second protruding member 32, and hence the medium 99 is curved in an undulating manner. In one example, as indicated with the broken lines in FIG. 3 and FIG. 4, the medium 99 is curved in a M-like shape by the supporting member 28, the first protruding member 31, and the second protruding member 32 as viewed in the first direction D1. With this, a crease extending in the first direction D1 is easily formed on the medium 99.

As illustrated in FIG. 2, the stacking unit 26 includes one or more stacking members. In one example, the stacking unit 26 includes a first stacking member 41 and a second stacking member 42. The stacking member extends in the first direction D1 from the supporting member 28. Specifically, the first stacking member 41 extends in the first direction D1 from the supporting member 28. The second stacking member 42 extends in the first direction D1 from the first stacking member 41. The supporting member 28, the first stacking member 41, and the second stacking member 42 are arrayed in the first direction D1 in the stated order. On the stacking member, the medium 99 guided to the supporting member 28 is stacked. The stacking member supports the medium 99 received by the supporting member 28. The stacking member supports the medium 99 in collaboration with the supporting member 28, the first protruding member 31, and the second protruding member 32.

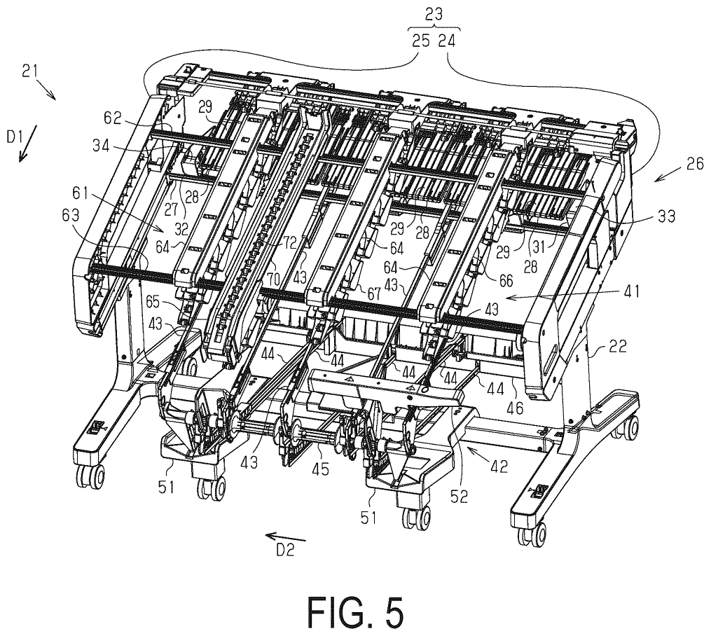

As illustrated in FIG. 2 and FIG. 5, the first stacking member 41 and the second stacking member 42 may be configured to be foldable. In one example, the second stacking member 42 is configured to be foldable so as to be positioned below the first stacking member 41. In other words, the second stacking member 42 is configured to be accommodated below the first stacking member 41. The second stacking member 42 is coupled so as to rotate with respect to the first stacking member 41. The second stacking member 42 rotates about a coupling part between the first stacking member 41 and the second stacking member 42 as an axis, with respect to the first stacking member 41. With this, the second stacking member 42 is displaced from the state illustrated in FIG. 2 to the state illustrated in FIG. 5. In a state in which the second stacking member 42 is folded, the first stacking member 41 and the second stacking member 42 are not arrayed in the first direction D1. When the second stacking member 42 is folded, the foot space of the medium stacking device 21 is reduced.

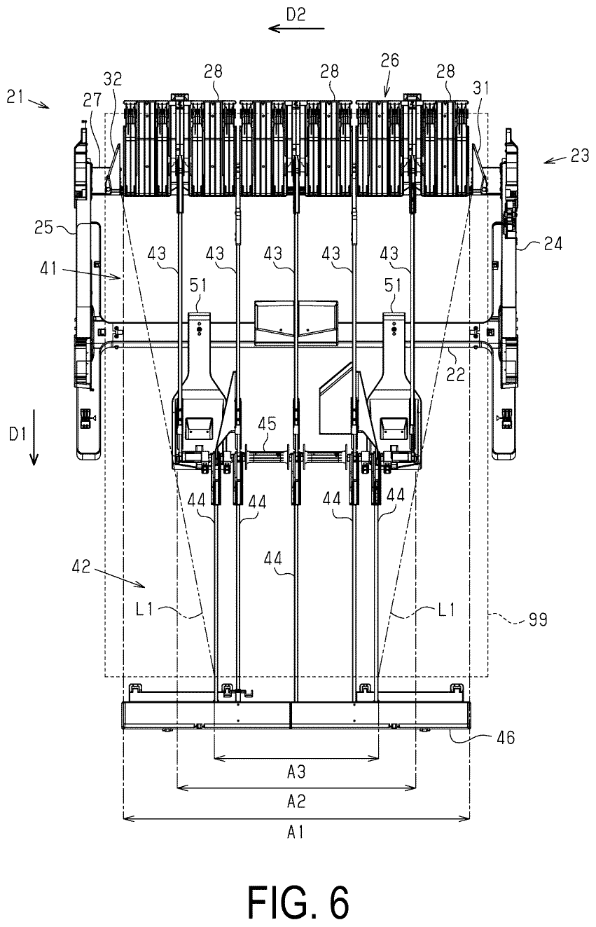

As illustrated in FIG. 6, the stacking member includes a plurality of ribs. Specifically, the first stacking member 41 includes a plurality of first ribs 43. In one example, the first stacking member 41 includes five first ribs 43. The second stacking member 42 includes a plurality of second ribs 44. In one example, the second stacking member 42 includes five second ribs 44. The plurality of ribs are positioned at an interval in the second direction D2. The plurality of ribs support the medium 99. The stacking member support the medium 99 guided to the supporting member 28. Thus, even when the stacking member supports the medium 99 by a rod-like member such as a rib, the posture of the medium 99 is maintained stabilized.

The stacking member includes a joining member. Specifically, the first stacking member 41 includes a first joining member 45. The second stacking member 42 includes a second joining member 46. The joining member extends in the second direction D2. The joining member joins the plurality of ribs to each another. The first joining member 45 joins the plurality of first ribs 43 to each other. The first joining member 45 joins the respective distal ends of the plurality of first ribs 43. The second joining member 46 joins the plurality of second ribs 44. The second joining member 46 joins the respective distal ends of the plurality of second ribs 44. The second joining member 46 may come into contact with a floor surface. With this, the posture of the second stacking member 42 is stabilized.

The first rib 43 extends in the first direction D1. The first rib 43 is attached to the bridging member 27 or the supporting member 28. In one example, the base end of the first rib 43 is attached to the bridging member 27 or the supporting member 28. The first rib 43 may be attached to the bridging member 27 or the supporting member 28 so as to rotate about the base end as an axis. For example, the plurality of first ribs 43 are symmetrically arrayed in the second direction D2, with the center of the first stacking member 41 as a reference. For example, the plurality of first ribs 43 are arrayed at an equal interval.

The plurality of first ribs 43 are arrayed at an interval in the second direction D2. The plurality of first ribs 43 support the medium 99. The medium 99 is supported on the plurality of first ribs 43, and hence is in an undulating state. With this, the medium 99 is less likely to curl. The part of the medium 99, which is supported on the plurality of first ribs 43, is curved more finely than the part thereof, which is supported on the supporting member 28.

The first rib 43 is positioned below the first protruding member 31 and the second protruding member 32. Specifically, the first rib 43 is positioned below the first protruding surface 33 and the second protruding surface 34. The first rib 43 extends at a position below the first protruding member 31 and the second protruding member 32. In other words, the first protruding member 31 and the second protruding member 32 are positioned so that the first protruding surface 33 and the second protruding surface 34 are positioned above the first rib 43. With this, the medium 99 easily advances from the supporting member 28 to the first rib 43.

As illustrated in FIG. 3 and FIG. 4, the plurality of first ribs 43 includes one or more first ribs 43 attached to the bridging member 27 and one or more first ribs 43 attached to the supporting member 28. In one example, among the five first ribs 43, the first ribs 43 that are arranged at the second position and the fourth position in the second direction D2 are attached to the bridging member 27. Among the five first ribs 43, the first ribs 43 that are arranged at the first position, the third position, and the fifth position in the second direction D2 are attached to the supporting member 28. The plurality of first ribs 43 may be attached only to the bridging member 27, or may be attached only to the supporting member 28.

The plurality of first ribs 43 may include one or more first ribs 43 positioned at a first height and one or more first ribs 43 positioned at a second height different from the first height. In one example, the height at which the first rib 43 attached to the bridging member 27 is positioned and the height at which the first rib 43 attached to the supporting member 28 are different from each other. Specifically, the first rib 43 attached to the bridging member 27 is positioned below the first rib 43 attached to the supporting member 28. With this, as indicated with the two-dot chain lines in FIG. 3 and FIG. 4, the medium 99 is curved in an undulating manner by the plurality of first ribs 43, as viewed in the first direction D1.

As illustrated in FIG. 6, the first stacking member 41 supports a part of the medium 99, which is positioned in a first stacking region A2, in the second direction D2. The first stacking region A2 is a region occupied by the plurality of first ribs 43 in the second direction D2. In other words, the first stacking region A2 is a region between the two first ribs 43 at the outermost ends in the second direction D2. In one example, the first stacking region A2 is a region from the first rib 43 arranged at the first position to the first rib 43 arranged at the fifth position in the second direction D2, among the five first ribs 43. As the length of the first stacking region A2 is smaller, the side edges of the medium 99 hang down significantly.

The first stacking region A2 is smaller than the supporting region A1. Thus, the side edges of the medium 99 hang down more significantly on the first stacking member 41 than on the supporting member 28. In other words, the stacking unit 26 supports the medium 99 so that a hanging amount of the side edge is increased toward the first direction D1. With this, the curve crease Li extending in the first direction D1, which is indicated with the two-dot chain line in FIG. 6, is easily formed on the medium 99. Specifically, both the side edges of the medium 99 hang down, and hence two curve creases Li are formed on the medium 99. The two curve creases Li extend so that the interval between the curve creases Li is reduced toward the first direction D1. When the side edge of the medium 99 hang down significantly, the risk that the medium 99 curls due to the curling tendency is reduced.

The second rib 44 extends in the first direction D1. The second rib 44 is attached to the first stacking member 41. Specifically, the second rib 44 is attached to the first joining member 45. In one example, the base end of the second rib 44 is attached to the first joining member 45. In one example, the second rib 44 is attached to the first joining member 45 so as to rotate about the base end as an axis. The second rib 44 is supported on the first joining member 45 so as to rotate with respect to the first joining member 45. With this, the second stacking member 42 is foldable with respect to the first stacking member 41. For example, the plurality of second ribs 44 are symmetrically arrayed in the second direction D2, with the center of the second stacking member 42 as a reference.

The second rib 44 may be positioned below the first rib 43. In one example, the second rib 44 extends below the first rib 43. With this, the medium 99 easily advances from the first rib 43 to the second rib 44.

Similarly to the first ribs 43, the plurality of second ribs 44 may include the plurality of second ribs 44 positioned at different heights. The plurality of second ribs 44 may include one or more second ribs 44 positioned at a third height and one or more second ribs 44 positioned at a fourth height different from the third height. In one example, among the five second ribs 44, the second ribs 44 that are arranged at the first position, the third position, and the fifth position in the second direction D2 are at the positions higher than the second ribs 44 that are arranged at the second position and the fourth position. The medium 99 is curved in an undulating manner by the plurality of second ribs 44.

The plurality of second ribs 44 are positioned at an interval smaller than the interval between the first ribs 43. In other words, the interval between the second ribs 44 is smaller than the interval between the first ribs 43. Specifically, the plurality of second ribs 44 includes the plurality of second ribs 44 arrayed at an interval smaller than the interval between the first ribs 43. In one example, among the five second ribs 44, the interval between the second rib 44 arranged at the first position and the second rib 44 arranged at the second position in the second direction D2 is smaller than the interval between the first ribs 43. Further, among the five second ribs 44, the interval between the second rib 44 arranged at the fourth position and the second rib 44 arranged at the fifth position in the second direction D2 is smaller than the interval between the first ribs 43. With this, the part of the medium 99, which is supported on the plurality of second ribs 44, is curved more finely than the part thereof, which is supported on the plurality of first ribs 43. With this, the medium 99 is less likely to curl. The plurality of second ribs 44 may be arranged at an equal interval in the second direction D2.

The second stacking member 42 supports a part of the medium 99, which is positioned in a second stacking region A3, in the second direction D2. The second stacking region A3 is a region occupied by the plurality of second ribs 44 in the second direction D2. In other words, the second stacking region A3 is a region between the two second ribs 44 on the outermost ends in the second direction D2. In one example, the second stacking region A3 is a region from the second rib 44 arranged at the first position to the second rib 44 arranged at the fifth position in the second direction D2, among the five second ribs 44.

The second stacking region A3 is smaller than the first stacking region A2. Thus, the side edges of the medium 99 hang down more significantly on the second stacking member 42 than on the first stacking member 41. In other words, the stacking unit 26 supports the medium 99 so that a hanging amount of the side edge is increased toward the first direction D1. With this, the curve crease Li, which is indicated with the two-dot chain line in FIG. 6, is easily formed on the medium 99. In the process that the medium 99 advances in the first direction D1 on the stacking unit 26, the leading edge of the medium 99 easily curls due to the curling tendency. This is because, in the process that the medium 99 advances, the trailing edge of the medium 99 is held by the discharge unit 20. In other words, the trailing edge of the medium 99 is held by the discharge unit 20 while the leading edge of the medium 99 is a free edge. Thus, in the process that the medium 99 advances in the first direction D1 on the stacking unit 26, the leading edge of the medium 99 curls more easily than the trailing edge of the medium 99. In contrast, when the medium 99 is supported so that the side edges of the medium 99 hang down more significantly toward the first direction D1, the risk that the medium 99 curls due to the curling tendency is reduced.

As illustrated in FIG. 2, the medium stacking device 21 may include an assisting unit 51. The assisting unit 51 is configured to assist the stacking unit 26. The assisting unit 51 is configured to support the stacking member. The assisting unit 51 is attached to the leg unit 22. The assisting unit 51 is attached to the stacking member. In one example, the assisting unit 51 is attached to the first stacking member 41. The assisting unit 51 is attached to the first joining member 45. The first stacking member 41 and the second stacking member 42 are elongated in the first direction D1, and hence a load of the coupling part is easily increased. The assisting unit 51 supports the first joining member 45, and hence a load on the coupling part is reduced. Therefore, the postures of the first stacking member 41 and the second stacking member 42 are stabilized.

The medium stacking device 21 includes a stopper 52. The stopper 52 is attached to the stacking unit 26. For example, the stopper 52 is attached to the stacking member. The stopper 52 is attached to the first stacking member 41 or the second stacking member 42. The stopper 52 is attached to the rib. In other words, the stopper 52 is attached to the first rib 43 or the second rib 44. In one example, the stopper 52 is attached to the first rib 43. The stopper 52 may be attached to the supporting member 28.

The stopper 52 comes into contact with the leading edge of the medium 99. With this, the stopper 52 receives and stops the medium 99. The stopper 52 stops the medium 99 advancing in the first direction D1 on the stacking unit 26. With this, the risk that the medium 99 falls from the stacking unit 26 is reduced.

The stopper 52 may be attached to the stacking unit 26 so as to be displaced in the first direction D1. The stopper 52 may be attached so as to move along the rib. The stopper 52 may be configured to be removably attached to the rib. With this, the stopper 52 may be displaced according to the length of the medium 99 to be discharged. For example, when the medium 99 has a large length, the stopper 52 may be displaced in the first direction D1. The stopper 52 can come into contact with the leading edge of the medium 99 at a freely-selected position in the first direction D1. The stopper 52 can stop the medium 99 at a freely-selected position in the first direction D1.

The stopper 52 includes an attaching part 53 attached to the rib. The attaching part 53 sandwiches the rib. With this, the stopper 52 is attached to the rib. The attaching part 53 is configured to sandwich or release the rib. Thus, the stopper 52 is configured to be removably attached to the rib. With this, the stopper 52 can be displaced in the first direction D1.

The medium stacking device 21 includes a regulating unit 61. The regulating unit 61 is positioned above the stacking unit 26. The regulating unit 61 is configured to press down the medium 99 stacked on the stacking unit 26, from above. The regulating unit 61 reduces the risk that the medium 99 curls, by pressing down the medium 99.

The regulating unit 61 includes one or more coupling members. In one example, the regulating unit 61 includes a first coupling member 62 and a second coupling member 63. The coupling member extends in the second direction D2. The coupling member is coupled to the first side frame 24 and the second side frame 25. The coupling member is bridged between the first side frame 24 and the second side frame 25. The first coupling member 62 and the second coupling member 63 are arrayed in the first direction D1 in the stated order.

The regulating unit 61 includes one or more regulating units. For example, the regulating unit 61 includes one or more first regulating units 64 and one or more second regulating units 65. In one example, the regulating unit 61 includes three first regulating units 64 and one second regulating unit 65.

The regulating unit presses down the medium 99 stacked on the stacking member. The first regulating unit 64 presses down the medium 99 stacked on the first stacking member 41. The first regulating unit 64 is positioned above the first stacking member 41. The first regulating unit 64 is attached to the first coupling member 62 and the second coupling member 63. The second regulating unit 65 presses down the medium 99 stacked on the second stacking member 42. The second regulating unit 65 is positioned above the second stacking member 42. The second regulating unit 65 is attached to the second coupling member 63.

The three first regulating units 64 are arrayed at an interval in the second direction D2. For example, the three first regulating units 64 are symmetrically arrayed in the second direction D2 with the center of the first stacking member 41 as a reference. For example, the three first regulating units 64 are arrayed at an equal interval.

The first regulating unit 64 is positioned so as to face the first rib 43. In other words, as viewed from above, the first regulating unit 64 overlaps with the first rib 43. With this, the first regulating unit 64 can press down a part of the medium 99, which floats up due to the first rib 43. As a result, a risk that the medium 99 is jammed is reduced. In one example, the three first regulating units 64 respectively face the first ribs 43 that are arranged at the first position, the third position, and the fifth position in the second direction D2, among the five first ribs 43.

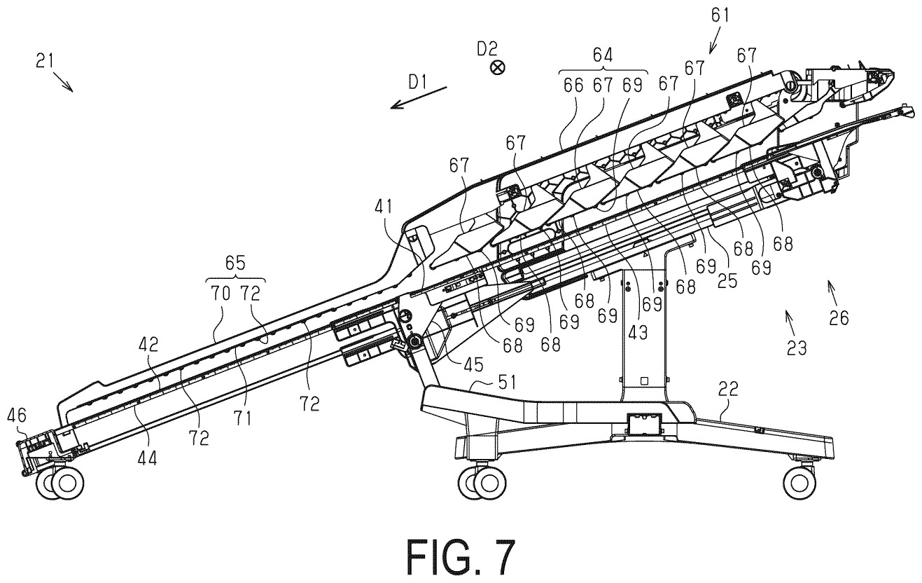

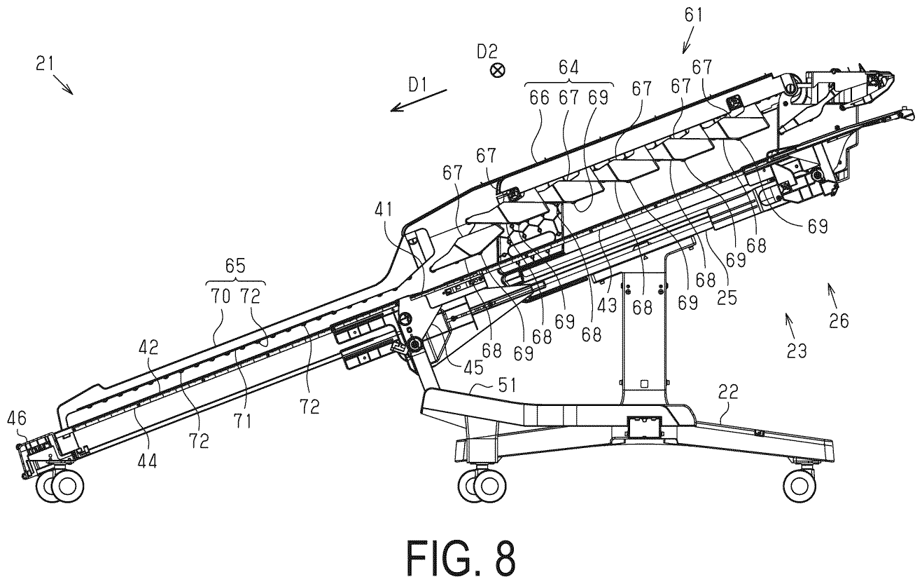

As illustrated in FIG. 7 and FIG. 8, the first regulating unit 64 includes a first attaching member 66 and one or more first regulating members 67. In one example, the first regulating unit 64 includes the first attaching member 66 and the plurality of first regulating members 67.

The first attaching member 66 extends in the first direction D1. The base end of the first attaching member 66 is attached to the first coupling member 62. The distal end of the first attaching member 66 is attached to the second coupling member 63. The first attaching member 66 is positioned so as to face the first rib 43.

The first regulating member 67 is attached to the first attaching member 66. The first regulating member 67 is attached so as to approach the first stacking member 41 from the first attaching member 66. The first regulating member 67 is attached so as to protrude downward from the first attaching member 66.

The first regulating member 67 comes into contact with the medium 99, and then presses down the medium 99. The first regulating member 67 includes a regulating surface that comes into contact with the medium 99 from above. In other words, the first regulating member 67 includes a first regulating surface 68. The first regulating surface 68 extends in the first direction D1. The first regulating member 67 is attached to the first attaching member 66 so that the first regulating surface 68 is parallel to the first rib 43.

The plurality of first regulating members 67 are arrayed in the first direction D1 on the first attaching member 66. As viewed in the second direction D2, the plurality of first regulating members 67 are arrayed in the first direction D1 so that the respective first regulating surfaces 68 are continuous with each other. As viewed in the second direction D2, the plurality of first regulating surfaces 68 are positioned to be continuous with each other. With this, a risk that the medium 99 advances into the gap between the first regulating member 67 is reduced. Therefore, a risk that the medium 99 is jammed is reduced.

The first regulating member 67 may be attached to swing with respect to the first attaching member 66. In one example, the first regulating member 67 swings with respect to the first attaching member 66 so that the first regulating surface 68 is oriented in the first direction D1. The first regulating member 67 is a flap. The first regulating member 67 receives a reaction force from the medium 99, and then swings so that the first regulating surface 68 is oriented in the first direction D1. With this, when the first regulating member 67 forcefully comes into contact with the medium 99, a risk that the medium 99 is jammed is reduced. For example, the plurality of first regulating members 67 swing independently from each other.

The first regulating unit 64 may include one or more rotation members. In one example, the first regulating unit 64 includes a plurality of first rotation members 69. The first rotation member 69 is a roller. The first rotation member 69 is attached to the first regulating member 67. The first rotation member 69 rotates with respect to the first regulating member 67. As viewed in the second direction D2, the first rotation member 69 is positioned to protrude from the first regulating surface 68 toward the first stacking member 41. The first rotation member 69 comes into contact with the medium 99 while the first regulating member 67 presses down the medium 99. The first rotation member 69 comes into contact with the medium 99, and then rotates. The first rotation member 69 rotates, and then guides the medium 99 in the first direction D1. Due to the first rotation member 69, a risk that the medium 99 is jammed is reduced.

As illustrated in FIG. 2, the second regulating unit 65 is positioned so as to face the second rib 44. In other words, as viewed from above, the second regulating unit 65 overlaps with the second rib 44. With this, the second regulating unit 65 can press down a part of the medium 99, which floats up due to the second rib 44. As a result, a risk that the medium 99 is jammed is reduced. In one example, the second regulating unit 65 faces the second rib 44 arranged at the fourth position in the second direction D2, among the five second ribs 44. This is for reducing the risk that the medium 99 having a small width curls. When the medium 99 has a small width, the side edges of the medium 99 may not sufficiently hang down. Specifically, the side edge positioned on the second direction D2 side with respect to the second rib 44 arranged at the fifth position in the second direction D2, among the five second ribs 44, may not sufficiently hang down. In this case, the curve crease Li is not easily formed, and hence there arises a risk that the medium 99 floats up. With regard to this point, the second regulating unit 65 is arranged to be deviated in the second direction D2 from the center of the second stacking member 42, and hence can press down a part of the medium 99, which easily floats up. With this, the risk that the medium 99 having a small width curls is reduced.

The second regulating unit 65 includes one or more second regulating members 70. In one example, the second regulating unit 65 includes on second regulating member 70. Similarly to the first regulating unit 64, the second regulating unit 65 may a plurality of second regulating members 70.

The second regulating member 70 extends in the first direction D1. The second regulating member 70 extends along the second rib 44 in an elongated manner. The second regulating member 70 is attached to the second coupling member 63. Specifically, the base end of the second regulating member 70 is supported on the second coupling member 63. The distal end of the second regulating member 70 is supported on the second stacking member 42. In one example, the distal end of the second regulating member 70 is supported on the second joining member 46. With this, the posture of the second regulating member 70 is stabilized.

The second regulating member 70 may be rotatably attached to the second coupling member 63. When the second stacking member 42 is folded, the second regulating member 70 can rotate about the part attached to the second coupling member 63 as an axis, and then can be retracted above the first regulating unit 64.

As illustrated in FIG. 7 and FIG. 8, the second regulating member 70 is positioned so as to face the second rib 44. The second regulating member 70 comes into contact with the medium 99, and then presses down the medium 99. The second regulating member 70 includes a regulating surface the presses down the medium 99. In other words, the second regulating member 70 includes a second regulating surface 71. The second regulating surface 71 extends in the first direction D1. The second regulating surface 71 is parallel to the second rib 44.

The second regulating unit 65 may one or more rotation members. In one example, the second regulating unit 65 includes a plurality of second rotating members 72. The second rotating member 72 is a roller. The second rotating member 72 is attached to the second regulating member 70. The second rotating member 72 rotates with respect to the second regulating member 70. As viewed in the second direction D2, the second rotating member 72 is positioned to protrude from the second regulating surface 71 toward the second stacking member 42. The second rotating member 72 comes into contact with the medium 99 while the second regulating member 70 presses down the medium 99. The second rotating member 72 is rotatable by coming into contact with the medium 99. The second rotating member 72 rotates, and then guides the medium 99 in the first direction D1. Due to the second rotating member 72, a risk that the medium 99 is jammed is reduced.

### Operations and Effects

Next, operations and effects of the above-mentioned examples are described.
(1) The first protruding surface 33 and the second protruding surface 34 are positioned above the supporting surface 29. The medium 99 may easily curl in the first direction D1 due to the curling tendency. According to the above-mentioned configuration, the first protruding member 31 and the second protruding member 32 support the medium 99 so as to lift up the medium 99 with respect to the supporting member 28. With this, on the medium 99, the curve crease Li is curved to extend in the first direction D1. As a result, the risk that the medium 99 curls due to the curling tendency is reduced.
(2) The first stacking member 41 includes the plurality of first ribs 43 extending in the first direction D1. According to the above-mentioned configuration, the medium 99 is supported on the plurality of first ribs 43, and hence is easily in an undulating state in the second direction D2. With this, the risk that the medium 99 curls due to the curling tendency is reduced.
(3) The first protruding member 31 and the second protruding member 32 are positioned so that the first protruding surface 33 and the second protruding surface 34 are positioned above the plurality of first ribs 43. According to the above-mentioned configuration, the medium 99 easily advances in the first direction D1 on the stacking unit 26.
(4) The interval between the second ribs 44 is smaller than the interval between the first ribs 43. According to the above-mentioned configuration, the medium 99 is supported on the plurality of second ribs 44, and hence is in a finer undulating state than the part thereof, which is supported on the plurality of first ribs 43. In other words, the part of the medium 99, which is supported on the plurality of second ribs 44, is in a finer undulating state than the part thereof, which is supported on the plurality of first ribs 43. With this, the risk that the medium 99 curls due to the curling tendency is reduced.
(5) the second stacking member 42 is configured to rotate about the coupling part between the first stacking member 41 and the second stacking member 42 as an axis, with respect to the first stacking member 41, and be accommodated below the first stacking member 41. According to the above-mentioned configuration, the second stacking member 42 is accommodated below the first stacking member 41, and hence the foot space of the medium stacking device 21 is reduced. With this, usability of the medium stacking device 21 is improved.
(6) The length of the second stacking region A3 is smaller than the length of the first stacking region A2. According to the above-mentioned configuration, the medium 99 is easily curved so that the curve crease Li extends from the first protruding member 31 and the second protruding member 32 to the second stacking member 42. With this, the risk that the medium 99 curls due to the curling tendency is reduced.
(7) The medium stacking device 21 includes the stopper 52 that is attached to the stacking unit 26 and comes into contact with the leading edge of the medium 99. According to the above-mentioned configuration, the stopper 52 comes into contact with the leading edge of the medium 99, and then stops the medium 99 on the stacking unit 26. Therefore, the risk that the medium 99 falls from the stacking unit 26 is reduced.
(8) The stopper 52 is attached to the stacking unit 26 so as to be displaced in the first direction D1. According to the above-mentioned configuration, the stopper 52 can be displaced according to the length of the medium 99. With this, the risk that the medium 99 falls from the stacking unit 26 is reduced.
(9) As viewed in the second direction D2, the plurality of first regulating surfaces 68 are positioned to be continuous with each other. According to the above-mentioned configuration, the plurality of first regulating surfaces 68 are positioned to be continuous with each other in the first direction D1, and hence there is no risk that the medium 99 enters the gap between the first regulating member 67. Therefore, a risk that the medium 99 is jammed is reduced.
(10) The plurality of first regulating members 67 swing with respect to the first attaching member 66 so that the first regulating surface 68 is oriented in the first direction D1. The medium 99 having significant rigidity may be stacked on the medium stacking device 21. In this case, when the medium 99 having significant rigidity forcefully comes into contact with the first regulating member 67, there is a risk that the medium 99 is damaged. According to the above-mentioned configuration, when the medium 99 pushes up the first regulating member 67, a risk that the medium 99 forcefully comes into contact with the first regulating member 67 is reduced.
(11) The first direction D1 is a direction extending obliquely downward. According to the above-mentioned configuration, the stacking unit 26 extends obliquely downward. Thus, the medium 99 discharged from the processing device 11 easily slides in the first direction D1 on the stacking unit 26 due to the gravity. With this, stacking of the medium 99 by the stacking unit 26 is facilitated.

### Modifications

The above-mentioned examples may be modified as follows for implementation. The above-mentioned examples and the following modifications may be combined for implementation insofar as they are not technically inconsistent.
Similarly to the second regulating unit 65, the first regulating unit 64 may be configured so that the first regulating member 67 is directly attached to the coupling member. For example, similarly to the second regulating member 70, the first regulating member 67 may be configured not to swing.
Similarly to the first regulating unit 64, the second regulating unit 65 may include an attaching member. For example, similarly to the first regulating member 67, the second regulating member 70 may be configured to swing.

### Technical Ideas

The following describes technical ideas and operational effects that are derived from the above-described examples and modifications.
(A) A medium stacking device is a medium stacking device on which a medium discharged from a processing device is stacked, the medium stacking device including a stacking unit on which a medium is stacked, the stacking unit extending in a first direction, wherein the stacking unit includes a supporting member configured to support a medium, and a first protruding member and a second protruding member each positioned on a respective side of the supporting member in a second direction different from the first direction, the supporting member includes a supporting surface that supports a medium, the first protruding member includes a first protruding surface that supports a medium, the second protruding member includes a second protruding surface that supports a medium, and the first protruding surface and the second protruding surface are positioned above the supporting surface. The medium may easily curl in the first direction due to the curling tendency. According to the above-mentioned configuration, the first protruding member and the second protruding member support the medium so as to lift up the medium with respect to the supporting member. With this, on the medium, a crease is curved to extend in the first direction. As a result, the risk that the medium curls due to the curling tendency is reduced.
(B) In the above-mentioned medium stacking device, the stacking unit may include a stacking member extending in the first direction from the supporting member, the stacking member may include a plurality of ribs extending in the first direction, and the plurality of ribs may be positioned at an interval in the second direction. According to the above-mentioned configuration, when the medium is supported on the plurality of ribs, the medium is easily in an undulating state in the second direction. With this, the risk that the medium curls due to the curling tendency is reduced.
(C) In the above-mentioned medium stacking device, the first protruding member and the second protruding member may be positioned so that the first protruding surface and the second protruding surface are positioned above the plurality of ribs. According to the above-mentioned configuration, on the stacking unit, the medium easily advances in the first direction.
(D) In the above-mentioned medium stacking device, the stacking member may be a first stacking member, the plurality of ribs may be a plurality of first ribs, the stacking unit may include a second stacking member extending in the first direction from the first stacking member, the second stacking member may include a plurality of second ribs extending in the first direction, the plurality of second ribs may be positioned at an interval in the second direction, and the interval between the second ribs may be smaller than the interval between the first ribs. According to the above-mentioned configuration, the medium is supported on the plurality of second ribs, and hence is in a finer undulating state than the part thereof, which is supported on the plurality of first ribs. In other words, the part of the medium, which is supported on the plurality of second ribs, is in a finer undulating state than the part thereof, which is supported on the plurality of first ribs. With this, the risk that the medium curls due to the curling tendency is reduced.
(E) In the above-mentioned medium stacking device, the second stacking member may be configured to be coupled to the first stacking member so as to rotate with respect to the first stacking member, and be accommodated below the first stacking member by rotating with respect to the first stacking member. According to the above-mentioned configuration, the second stacking member is accommodated below the first stacking member, and hence the foot space of the medium stacking device is reduced. With this, usability of the medium stacking device is improved.
(F) In the above-mentioned medium stacking device, a width of a region occupied by the plurality of second ribs in the second direction may be smaller than a width of a region occupied by the plurality of first ribs in the second direction. According to the above-mentioned configuration, the medium is easily curved so that a crease extends from the first protruding member and the second protruding member to the second stacking member. With this, the risk that the medium curls due to the curling tendency is reduced.
(G) The above-mentioned medium stacking device may include a stopper being attached to the stacking unit and coming into contact with a leading edge of a medium. According to the above-mentioned configuration, the stopper comes into contact with the leading edge of the medium, and then stops the medium on the stacking unit. Therefore, the risk that the medium falls from the stacking unit is reduced.
(H) In the above-mentioned medium stacking device, the stopper may be attached to the stacking unit so as to be displaced in the first direction. According to the above-mentioned configuration, the stopper can be displaced according to the length of the medium. With this, the risk that the medium falls from the stacking unit is reduced.
(I) The above-mentioned medium stacking device may include a regulating unit positioned above the stacking unit, wherein the regulating unit may include a plurality of regulating members arrayed in the first direction, the plurality of regulating members may respectively include regulating surfaces that come into contact with a medium from above, and the plurality of regulating surfaces may be continuously positioned as viewed in the second direction. According to the above-mentioned configuration, the plurality of regulating surfaces are positioned to be continuous with each other in the first direction, and hence there is no risk that the medium enters the gap between the regulating member. Therefore, a risk that the medium is jammed is reduced.
(J) In the above-mentioned medium stacking device, the regulating unit may include an attaching member to which each of the plurality of regulating members is swingably attached, and the plurality of regulating members may swing with respect to the attaching member so that the regulating surfaces are oriented in the first direction. The medium having significant rigidity may be stacked on the medium stacking device. In this case, when the medium having significant rigidity forcefully comes into contact with the regulating member, there is a risk that the medium is damaged. According to the above-mentioned configuration, when the medium pushes up the regulating member, a risk that the medium forcefully comes into contact with the regulating member is reduced.
(K) In the above-mentioned medium stacking device, the first direction may be an obliquely downward direction. According to the above-mentioned configuration, the stacking unit extends obliquely downward. Thus, the medium discharged from the processing device easily slides in the first direction on the stacking unit due to the gravity. With this, stacking of the medium by the stacking unit is facilitated.

What is claimed is:

1. A medium stacking device on which a medium discharged from a processing device is stacked, the medium stacking device comprising
a stacking unit on which a medium is stacked, the stacking unit extending in a first direction, wherein
the stacking unit includes:
a supporting member configured to support a medium; and
a first protruding member and a second protruding member each positioned on a respective side of the supporting member in a second direction different from the first direction,
the supporting member includes a supporting surface configured to support a medium,
the first protruding member includes a first protruding surface configured to support a medium,
the second protruding member includes a second protruding surface configured to support a medium, and
the first protruding surface and the second protruding surface are positioned above the supporting surface.

2. The medium stacking device according to claim 1, wherein
the stacking unit includes a stacking member extending in the first direction from the supporting member,
the stacking member includes a plurality of ribs extending in the first direction, and
the plurality of ribs are positioned at an interval in the second direction.

3. The medium stacking device according to claim 2, wherein
the first protruding member and the second protruding member are positioned so that the first protruding surface and the second protruding surface are positioned above the plurality of ribs.

4. The medium stacking device according to claim 2, wherein
the stacking member is a first stacking member,
the plurality of ribs are a plurality of first ribs,
the stacking unit includes a second stacking member extending in the first direction from the first stacking member,
the second stacking member includes a plurality of second ribs extending in the first direction,
the plurality of second ribs are positioned at an interval in the second direction, and
the interval between the plurality of second ribs is smaller than the interval between the plurality of first ribs.

5. The medium stacking device according to claim 4, wherein
the second stacking member is configured to
be coupled to the first stacking member so as to rotate with respect to the first stacking member, and
be accommodated below the first stacking member by rotating with respect to the first stacking member.

6. The medium stacking device according to claim 4, wherein
a width of a region occupied by the plurality of second ribs in the second direction is smaller than a width of a region occupied by the plurality of first ribs in the second direction.

7. The medium stacking device according to claim 1, comprising
a stopper being attached to the stacking unit and coming into contact with a leading edge of a medium.

8. The medium stacking device according to claim 7, wherein
the stopper is attached to the stacking unit so as to be displaced in the first direction.

9. The medium stacking device according to claim 1, comprising
a regulating unit positioned above the stacking unit, wherein
the regulating unit includes a plurality of regulating members arrayed in the first direction,
each of the plurality of regulating members includes a regulating surface configured to come into contact with a medium from above, and
the plurality of regulating surfaces are positioned so as to be continuous as viewed in the second direction.

10. The medium stacking device according to claim 9, wherein
the regulating unit includes an attaching member to which each of the plurality of regulating members is swingably attached, and
the plurality of regulating members swing with respect to the attaching member so that the regulating surfaces are oriented in the first direction.

11. The medium stacking device according to claim 1, wherein
the first direction is an obliquely downward direction.
